(19) United States
(12) Patent Application Publication
(10) Pub. No.: US 2012/0238392 A1
(43) Pub. Date: Sep. 20, 2012

(54) Belt Planetary Transmission

(76) Inventors: Alexander Serkh, Troy, MI (US); Dean Schneider, Washington, MI (US); Imtiaz Ali, Lathrup Village, MI (US); Peter Ward, Farmington Hills, MI (US)

(21) Appl. No.: 13/048,982

(22) Filed: Mar. 16, 2011

(51) Int. Cl. F16H 9/26

(52) U.S. Cl. 475/182

(57) ABSTRACT

A belt planetary transmission comprising a sun gear (1) having sun gear teeth (11), a ring gear (3) having ring gear teeth (31), a first toothed belt (4) trained between a first idler (50 and a second idler (51), the first idler and the second idler rotationally connected to a carrier (2), the first toothed belt (4) in simultaneous meshing contact with the ring gear teeth and the sun gear teeth, a second toothed belt (40) trained between a third idler (401) and a fourth idler (402), the third idler and the fourth idler rotationally connected to the carrier, the second toothed belt in simultaneous meshing contact with the ring gear teeth and the sun gear teeth, each of the first idler, second idler, third idler and fourth idler having a center of rotation disposed at a radius (R) from a center of rotation (A-A), and the first toothed belt and the second toothed belt are each in continuous meshing contact with the ring gear teeth and the sun gear teeth through an angle (α) of approximately 90°.

### FIELD OF THE INVENTION

The invention relates to a belt planetary transmission, and more particularly, to a belt planetary transmission comprising a sun gear, a ring gear, a first toothed belt trained between a first idler and a second idler, the first idler and the second idler rotationally connected to a carrier, the first toothed belt in simultaneous meshing contact with the ring gear and the sun gear, a second toothed belt trained between a third idler and a fourth idler, the third idler and the fourth idler rotationally connected to the carrier, the second toothed belt in simultaneous meshing contact with the ring gear and the sun gear.

### BACKGROUND OF THE INVENTION

The invention relates to low-friction rotating devices that require no or little lubrication. Prior rotary devices, such as roller bearings, require lubrication to reduce friction and are prone to failure if not properly lubricated and maintained. In these prior art devices, friction between two surfaces, such as a bearing surface and a roller bearing, degrade the efficiency of the device, and produce undesirable heat and wear that can damage the rolling surfaces, break down needed lubrication and reduce the useful life of the device.

The lubrication required for most prior art rotary devices reduces the operating efficiency of the devices; must be filtered, replaced or shielded; limits the operating environment to conditions favorable to lubrication; traps dirt and grit, and necessitates seals and dust covers to protect the lubrication. In addition, these seals and dust covers contribute to friction losses. Furthermore, prior art rotary devices generally are manufactured to narrow tolerances that necessitate high degrees of manufacturing accuracy that make the manufacture of such devices expensive and difficult.

The lubricants needed for prior rotary devices degrade, trap particles between rotating surfaces and perform poorly in extreme conditions. Prior rotary devices are susceptible to dirt, grit and other debris suspended in the lubricant. Debris and grit caught between the contacting surfaces in a conventional rotary device tends to gouge surfaces and cause seizure of the rotating elements of the device. In addition, lubricants tend to degrade, evaporate or slide off surfaces during long term storage of rotary devices.

It is believed that prior rotary roller band devices failed principally due to band failure caused by rubbing between adjacent bands, and to unwanted sliding between the bands and band guideways resulting from inadequate contact between the bands and guideways.

Representative of the art is U.S. Pat. No. 5,462,363 to Brinkman which discloses a rotary roller band device having a central roller disposed within a cluster of orbiting rollers and rows of flexible bands holding the rollers together in a self-supporting structure. The bands are intertwined between the rollers such that as the rollers rotate the bands loop around and between the rollers. The bands engage each of the rollers in a low friction rolling contact that does not require lubrication. The bands each form a C-shaped loop. The central roller is cupped inside the C of each band loop such that the outer surface of each band contacts with the surface of the central roller. The orbiting rollers are concentrically arranged around the central roller and rotate counter to the central roller. Each of the orbiting rollers is disposed inside of the loop of each band such that the outer orbiting rollers engage the inner surface of each band.

What is needed is a belt planetary transmission comprising a sun gear, a ring gear, a first toothed belt trained between a first idler and a second idler, the first idler and the second idler rotationally connected to a carrier, the first toothed belt in simultaneous meshing contact with the ring gear and the sun gear, a second toothed belt trained between a third idler and a fourth idler, the third idler and the fourth idler rotationally connected to the carrier, the second toothed belt in simultaneous meshing contact with the ring gear and the sun gear. The present invention meets this need.

### SUMMARY OF THE INVENTION

The primary aspect of the invention is a belt planetary transmission comprising a sun gear, a ring gear, a first toothed belt trained between a first idler and a second idler, the first idler and the second idler rotationally connected to a carrier, the first toothed belt in simultaneous meshing contact with the ring gear and the sun gear, a second toothed belt trained between a third idler and a fourth idler, the third idler and the fourth idler rotationally connected to the carrier, the second toothed belt in simultaneous meshing contact with the ring gear and the sun gear.

Other aspects of the invention will be pointed out or made obvious by the following description of the invention and the accompanying drawings.

The invention comprises a belt planetary transmission comprising a sun gear (1) having sun gear teeth (11), a ring gear (3) having ring gear teeth (31), a first toothed belt (4) trained between a first idler (50) and a second idler (51), the first idler and the second idler rotationally connected to a carrier (2), the first toothed belt (4) in simultaneous meshing contact with the ring gear teeth and the sun gear teeth, a second toothed belt (40) trained between a third idler (401) and a fourth idler (402), the third idler and the fourth idler rotationally connected to the carrier, the second toothed belt in simultaneous meshing contact with the ring gear teeth and the sun gear teeth, each of the first idler, second idler, third idler and fourth idler having a center of rotation disposed at a radius (R) from a center of rotation (A-A), and the first toothed belt and the second toothed belt are each in continuous meshing contact with the ring gear teeth and the sun gear teeth through an angle (α) of approximately 90°.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front view of the transmission.

FIG. 2 is an exploded view of the transmission.

FIG. 3 is a detail of a guide.

FIG. 4 is a detail of an idler.

FIG. 5 is a transparent side view of the flat belt planetary transmission embodiment.

FIG. 6 is a chart showing belt tension as a function of output torque for the synchronous belt.

FIG. 7 is a front view of an alternate embodiment of the transmission.

FIG. 8 is an exploded view of the v-belt or multi-ribbed belt embodiment.

### DETAILED DESCRIPTION OF THE PREFERRED EMBODIMENT

The belt planetary transmission uses some of the same elements of a planetary gear in that it has a sun gear, a carrier, and a ring gear. However, instead of using planetary gears to transmit power it uses belts and idlers.

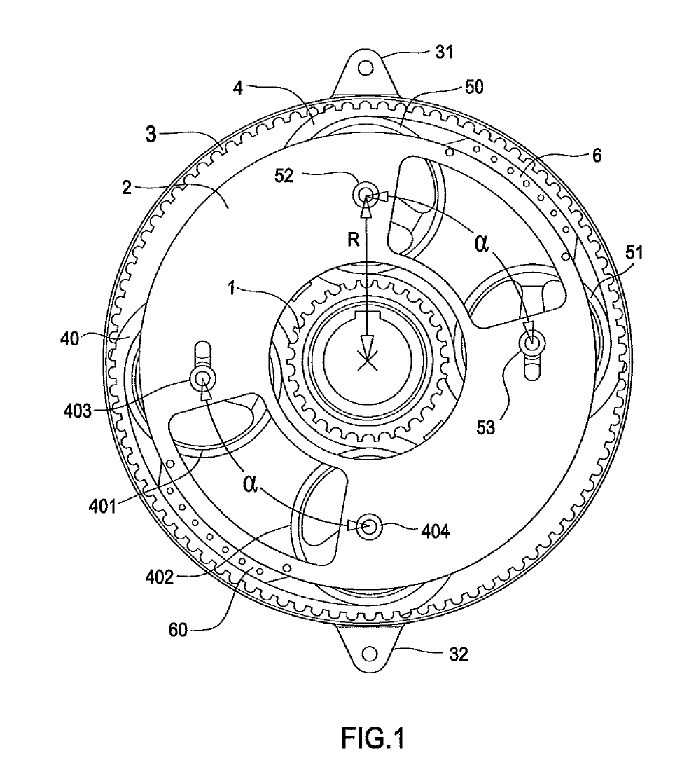

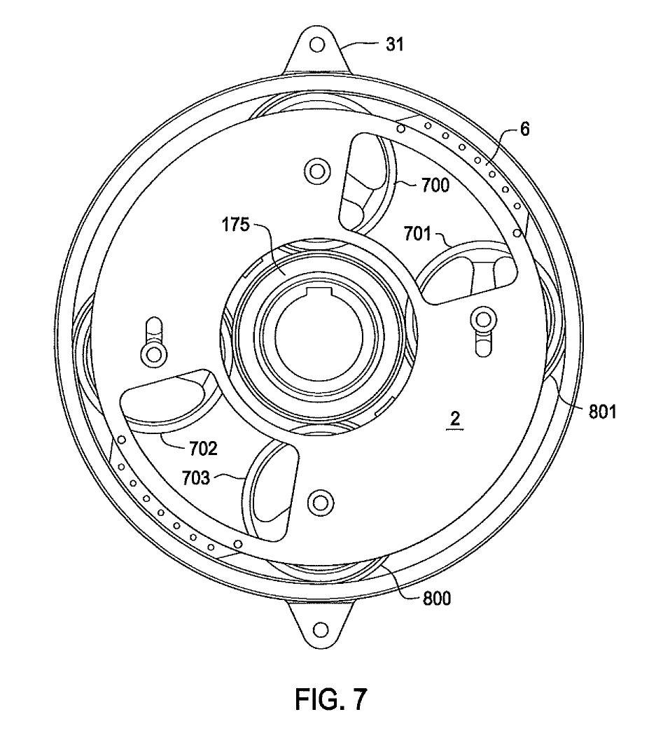

FIG. 1 is a front view of the transmission. Input sun gear 1 is a belt sprocket that drives or is driven by toothed belt 4 and toothed belt 40. Each belt 4 and belt replace the teeth on the pinion of a traditional planetary gear set. Sun gear 1 is mountable to an input shaft 90. Sun gear 1 comprises teeth 11 on an outer surface. In an alternate embodiment using a flat belt, teeth 11 are replaced with a flat surface. In an alternate embodiment using a v-belt or multi-ribbed belt, teeth 11 are replaced with a grooves, see FIG. 7.

Belt 4 is supported by idler 50 and idler 51. Idler 50 and idler 51 are each mounted on a bearing and spindle 52, 53, that allows belt 4 to easily rotate. Idler 50 and idler 51 each have a predetermined diameter that in cooperation with the inside diameter of ring gear 3 and the outside diameter of sun gear 1 simultaneously keep belt 4 in proper meshing contact with sun gear 1 and ring gear 3.

Guide 6 assists with keeping belt 4 in contact with ring gear 3. Belt 4 is held in meshing contact with ring gear 3 and sun gear 1 through an angle a which is approximately 90°.

Belt 40 is supported by idler 401 and idler 402. Idler 401 and idler 402 are each mounted on a bearing and spindle 403, 404, that allows belt 40 to easily rotate. Idler 401 and idler 402 each have a predetermined diameter that in cooperation with the inside diameter of ring gear 3 and the outside diameter of sun gear 1 simultaneously keep belt 40 in proper meshing contact with sun gear I and ring gear 3.

Guide 60 assists with keeping belt 40 in contact with ring gear 3. Belt 40 is held in meshing contact with ring gear 3 and sun gear 1 through an angle a which is approximately 90°.

Belt 4 and belt 40 are coplanar in that they are each disposed in and each operate in substantially the same plane (P) which is defined between first side 21 and second side 22 of carrier 2. Each idler 50, 51, 401 and 402 are coplanar in that they are each disposed in and each operate in substantially the same plane (P). Further, each idler 50, 51, 401 and 402 has a center of rotation that is located at the same radius (R) from the center of rotation (A-A) of sun gear 1. A combination of two idlers, for example 50, 51 and a belt 4, may also be referred to as a planetary assembly. Each transmission may have any number of planetary assemblies limited only by the size of the transmission.

Output carrier 2 has the same function as a carrier in a traditional planetary gear set. Carrier 2 comprises a first side 21 that is attached to a second side 22. First side 21 and second side 22 are parallel.

Carrier 2, and more particularly first side 21 and second side 22, is used to properly locate idler 50, idler 51, idler 401 and idler 402 which are each mounted thereto, and thereby belt 4 and belt 40 are located relative to sun gear 1 and ring gear 3. Carrier 2 can be used as an output member or reaction member depending on the desired transmission ratio.

Ring gear 3 is fixed to a mounting surface using mounting brackets 31, 32. Ring gear 3 comprises teeth 31 extending around an inner surface. Teeth 31 engage groves and 42 on each of the toothed belts 4 and 40 respectively. In an alternate embodiment using a flat belt, teeth 31 are replaced with a flat surface. In an alternate embodiment using a v-belt or multi-ribbed belt, teeth 31 are replaced with a grooves, see FIG. 7.

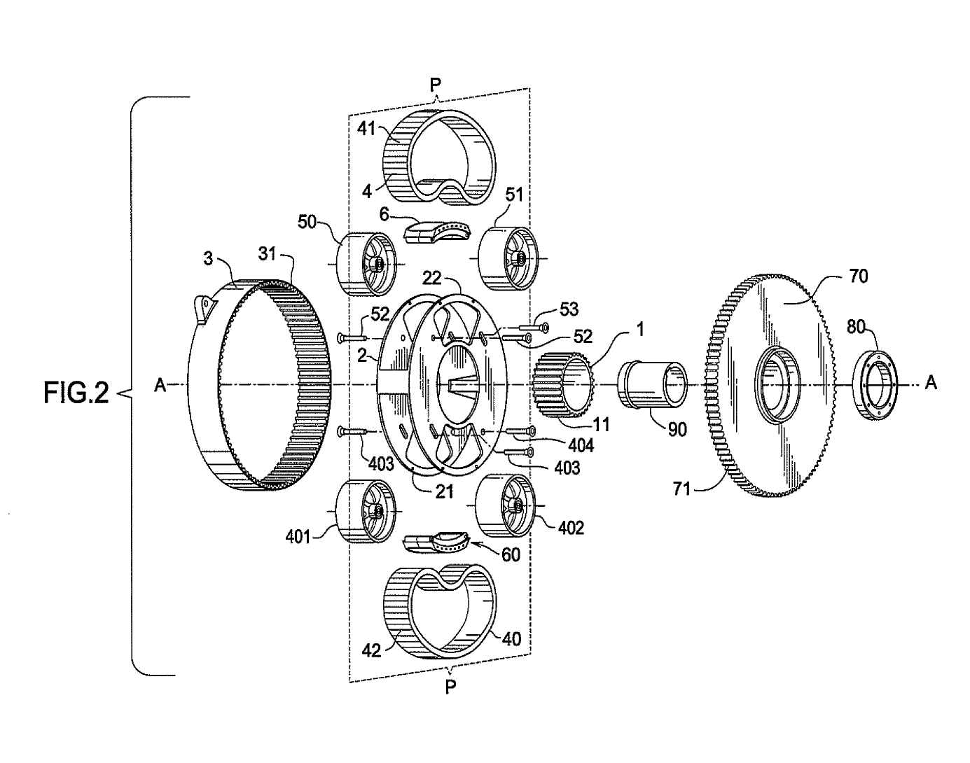

FIG. 2 is an exploded view of the transmission. Gear 70 is connected to carrier 2. Gear 70 can be connected to a machine via a chain, belt or gear or other power transmission device that is engaged with teeth 71. Bearing allows gear 70 to be mounted to shaft 90 in order to reduce the overall size of the device.

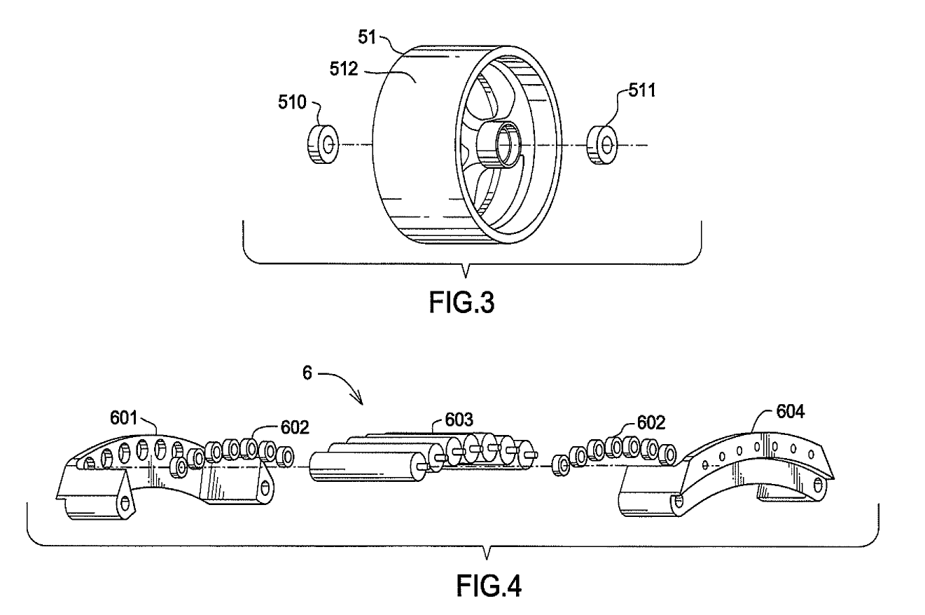

FIG. 3 is a detail of a guide. Each guide 6 and 60 comprises a frame member 601 and 604. Disposed between each frame member are rollers 603. Each end of a roller 603 is mounted to each frame member by a bearing 602.

In operation each of the rollers 603 contact and urge a portion of each toothed belt 4, 40 into contact with ring gear 3.

FIG. 4 is a detail of an idler. Each idler 50, 51, 401, 402 rotationally mounts to a shaft 52, 53, 403, 404 respectively on a bearing. Idler 51 mounts to shaft 53 on bearings 510, 511; like bearings are provided for each idler 50, 410 and 402. An outer surface 512 of the idler 51 is smooth. Each of idlers 53, 403, 404 also have a smooth outer surface which contacts the belt 4, 40.

Referring to FIG. 5, which is a transparent side view of the flat belt planetary transmission embodiment. In this embodiment flat belts are used instead of toothed belts 4, 40. Also in this embodiment there are no teeth 31 on ring gear 3 nor teeth 11 on sun gear 1, instead, each surface 31 and surface 11 is smooth. All torque transmission is through a frictional engagement between each belt and the smooth surface of the ring gear and the smooth surface of the sun gear.

A Sample Flat Belt Tension Calculation is as Follows:

1. Input, sun gear (1): S
2. Reaction, ring gear (3): R
3. Output, carrier (2)

### 4. Planet: P

### 5. Planet Pitch Radius: rp

6. Number of belts: N_{b}

### 7. Torque Input: Tᵢ

### 8. Torque Output:

$${T}_{o} = {T}_{i} ( 1 + \frac{R}{S} )$$

### 9. Torque Planet: Tₚ

### 10. Ratio:

$$1 + \frac{R}{S} = \frac{To}{Ti} = \frac{Wi}{Wo}$$

### 11. Belt Tension,

$$F = \frac{Ftight + Fslack}{2}$$

12.

$$\frac{Ftight}{Fslack} = {e}^{μ∅}$$

i. μ=Coefficient of friction
ii. Ø=wrap angle

### Solution:

1. Planet assembly torque.

$$a ) Tp = \frac{2 Ti}{Nb} ( \frac{P}{2} ) = \frac{TiP}{NbS}$$

2. Belt tension as a function of tight and slack side tensions.

$$a ) Belt Tension = \frac{Ftight + Fslack}{2} \\ b ) \frac{Ftight}{Fslack} = {e}^{μ∅} \\ i ) Fslack = \frac{Ftight}{{e}^{μ ∅}} \\ c ) Belt Tension = \frac{1}{2} Ftight ( 1 + \frac{1}{{e}^{μ ∅}} )$$

3. Belt tight side tension as a function of torque at planet assembly.

$$a ) {T}_{p} = rp ( Ftight - Fslack ) \\ b ) {T}_{p} = rp ( Ftight - \frac{Ftight}{{e}^{μ∅}} )$$

4. Belt tight side tension as a function of planet assembly torque.

$$a ) Ftight = \frac{Tp}{rp ( 1 - \frac{1}{{e}^{μ ∅}} )}$$

5. Belt tension as a function of planet assembly torque.

$$a ) \frac{1}{2} [ \frac{Tp}{rp ( 1 - \frac{1}{{e}^{μ ∅}} )} ] [ 1 + \frac{1}{{e}^{μ ∅}} ] \\ b ) \frac{Tp}{2 rp} ( \frac{1 + \frac{1}{{e}^{μ ∅}}}{1 - \frac{1}{{e}^{μ ∅}}} ) \\ c ) \frac{Tp}{2 rp} ( \frac{{e}^{μ ∅} + 1}{{e}^{μ ∅} - 1} )$$

6. Belt tension as a function of input torque, number of belts, planet assembly, sun gear, coefficient of friction, and belt wrap angle.

$$a ) Belt tension = \frac{TiP}{2 NbSrp} ( \frac{{e}^{μ ∅} + 1}{{e}^{μ ∅} - 1} )$$

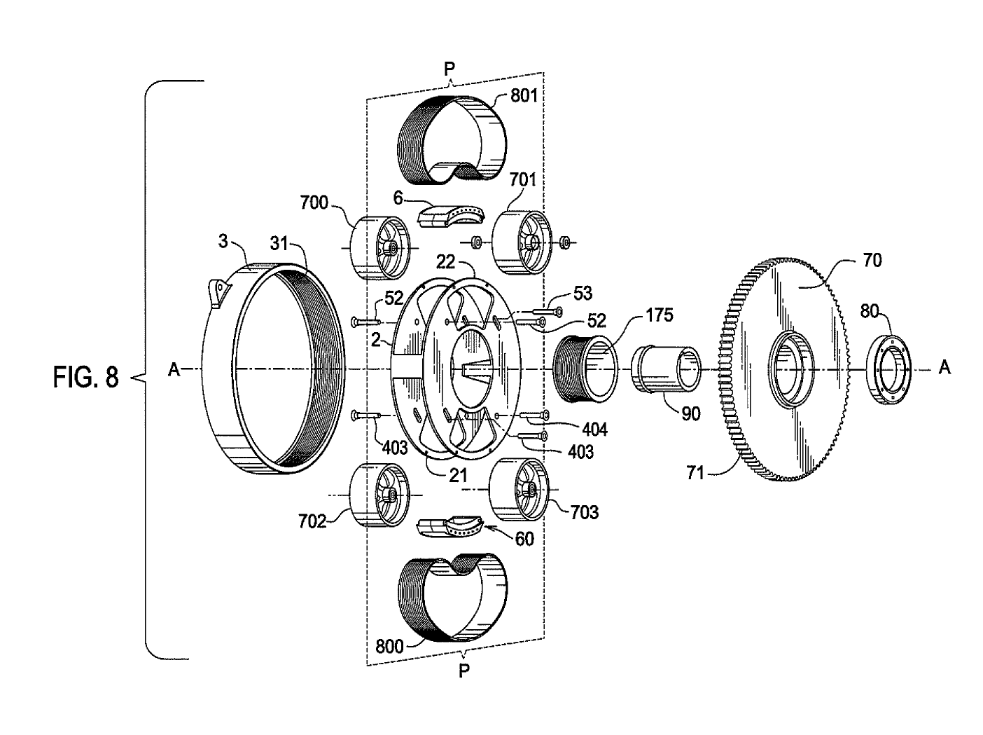

In yet another alternate embodiment, the inventive device may also use a v-belt or multi-ribbed belt. FIG. 8 is an exploded view of the v-belt or multi-ribbed belt embodiment. A sample calculation follows.

Sample Belt Calculation Using V-Belt or Multi-Ribbed Belts for the Belt Planetary Drive.

1. Input, sun gear (1): S
2. Reaction, ring gear (3): R
3. Output, carrier (2)

### 4. Planet: P

### 5. Planet Pitch Radius: rp

6. Number of belts: N_{b}

### 7. Torque Input: Tᵢ

### 8. Torque Output:

$${T}_{o} = {T}_{i} ( 1 + \frac{R}{S} )$$

### 9. Torque Planet: Tₚ

### 10. Ratio:

$$1 + \frac{R}{S} = \frac{To}{Ti} = \frac{Wi}{Wo}$$

### 11. Belt Tension,

$$F = \frac{Ftight + Fslack}{2}$$

12.

$$\frac{Ftight}{Fslack} = {e}^{μω∅}$$

i. μ=Coefficient of friction
ii. ω=Wedging Factor (V or micro-V)
iii. Ø=wrap angle

### Solution:

1. Planet assembly torque.

$$a ) Tp = \frac{2 Ti}{Nb} ( \frac{P}{2} ) = \frac{TiP}{NbS}$$

2. Belt tension as a function of tight and slack side tensions.

$$a ) Belt Tension = \frac{Ftight + Fslack}{2} \\ b ) \frac{Ftight}{Fslack} = {e}^{μω∅} \\ i ) Fslack = \frac{Ftight}{{e}^{μω∅}} \\ c ) Belt Tension = \frac{1}{2} Ftight ( 1 + \frac{1}{{e}^{μω∅}} )$$

3. Belt tight side tension as a function of torque at planet assembly.

$$a ) {T}_{p} = rp ( Ftight - Fslack \\ b ) {T}_{p} = rp ( Ftight - \frac{Ftight}{{e}^{μω∅}} ) \\ c ) Ftight = \frac{Tp}{rp ( 1 - \frac{1}{{e}^{μω∅}} )}$$

4. Belt tension as a function of planet assembly torque.

$$a ) \frac{1}{2} [ \frac{Tp}{rp ( 1 - \frac{1}{{e}^{μω∅}} )} ] [ 1 + \frac{1}{{e}^{μω∅}} ] \\ b ) \frac{Tp}{2 rp} ( \frac{1 + \frac{1}{{e}^{μω∅}}}{1 - \frac{1}{{e}^{μω∅}}} ) \\ c ) \frac{Tp}{2 rp} ( \frac{{e}^{μω∅} + 1}{{e}^{μω∅} - 1} )$$

5. Belt tension as a function of input torque, number of belts, planet assembly, sun gear, coefficient of friction, and belt wrap angle.

$$a ) Belt tension = \frac{TiP}{2 NbSrp} ( \frac{{e}^{μω∅} + 1}{{e}^{μω∅} - 1} )$$

Sample Belt Tension Calculation Using Synchronous Belts in the Belt Planetary Drive.

1. Input, sun gear (1): S
2. Reaction, ring gear (3): R
3. Output, carrier (2)

### 4. Planet: P

### 5. Planet Pitch Radius: rp

6. Number of belts: N_{b}

### 7. Torque Input: Tᵢ

### 8. Torque Output:

$${T}_{o} = {T}_{i} ( 1 + \frac{R}{S} )$$

### 9. Torque Planet: Tₚ

### 10. Ratio:

$$1 + \frac{R}{S} = \frac{To}{Ti} = \frac{Wi}{Wo}$$

### 11. Belt Tension,

$$F = \frac{Ftight + Fslack}{2}$$

12.

$$\frac{Ftight}{Fslack} = 8$$

(design assumption)

### Solution:

1. Planet assembly torque.

$$a ) Tp = \frac{2 Ti}{Nb} ( \frac{P}{2} ) = \frac{TiP}{NbS}$$

2. Belt Tension as a function of tight and slack side tensions.

$$a ) Belt Tension = \frac{Ftight + Fslack}{2} \\ b ) \frac{Ftight}{Fslack} = 8 \\ i ) Fslack = \frac{Ftight}{8} \\ c ) Belt Tension = \frac{1}{2} ( Ftight + \frac{Ftight}{8} ) \\ d ) Belt Tension = \frac{9}{16} Ftight$$

3. Tight Side Tension as a function of torque at planet assembly.

$$a ) {T}_{p} = rp ( Ftight - Fslack \\ b ) {T}_{p} = rp ( Ftight - \frac{Ftight}{8} ) \\ c ) {T}_{p} = \frac{7}{8} Ftight rp \\ d ) Ftight = \frac{8 Tp}{7 rp}$$

4. Belt Tension as a function of planet assembly torque.

$$a ) Belt Tension = \frac{9}{16} Ftight \\ b ) Belt Tension = \frac{9}{16} ( \frac{8 Tp}{7 rp} ) \\ c ) Belt Tension = \frac{9 Tp}{14 rp}$$

5. Belt Tension as a function of input torque, number of belts, planet assembly, sun gear, coefficient of friction, and belt wrap angle.

$$d ) Belt tension = \frac{9 TiP}{14 rpNbS}$$

By way of example and not of limitation, following is a sample solution for two planetary transmissions, the first using two synchronous belts and the second using three synchronous belts.

| Known | | | Known | | |
|---|---|---|---|---|---|
| Belt Pitch (mm) 14 | | | Belt Pitch (mm) 14 | | |
| | | Pitch | | | Pitch |
| | # of | Diameter | | # of | Diameter |
| | Grooves | (m) | | Grooves | (m) |
| Sun gear | 30 | 0.133690152 | Sun gear | 30 | 0.133690152 |
| (1) | | | (1) | | |
| Ring gear | 90 | 0.401070457 | Ring gear | 90 | 0.401070457 |
| (3) | | | (3) | | |
| Planet | 30 | 0.133690152 | Planet | 30 | 0.133690152 |
| assembly | | | assembly | | |
| Ratio | 4 | | Ratio | 4 | |
| Number of | 2 | | Number of | 3 | |
| Belts | | | Belts | | |

| Input Torque | Belt Tension (N) | Belt Tension (N) |
|---|---|---|
| (Nm) | with 2 Belts | with 3 Belts |
| 0 | 0 | 0 |
| 5 | 12.02140046 | 8.014266973 |
| 10 | 24.04280092 | 16.02853395 |
| 15 | 36.06420138 | 24.04280092 |
| 20 | 48.08560184 | 32.05706789 |
| 25 | 60.1070023 | 40.07133487 |
| 30 | 72.12840276 | 48.08560184 |
| 35 | 84.14980322 | 56.09986881 |
| 40 | 96.17120368 | 64.11413579 |
| 45 | 108.1926041 | 72.12840276 |
| 50 | 120.2140046 | 80.14266973 |

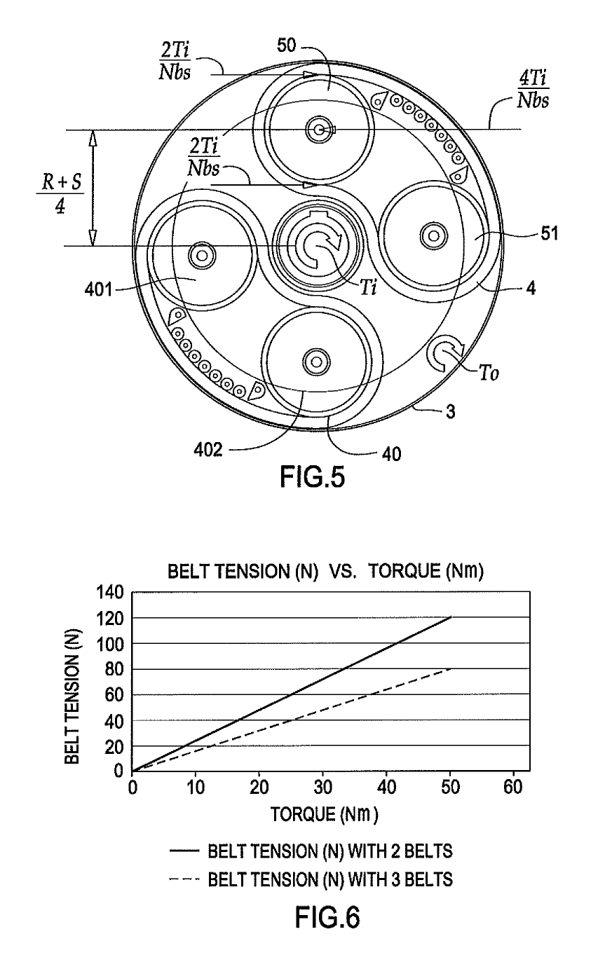

FIG. 6 is a chart showing belt tension as a function of output torque for the synchronous belt. FIG. 6 depicts a two belt embodiment and a three belt embodiment.

FIG. 7 is a front view of an alternate embodiment of the transmission. In this embodiment the belts comprise multi-ribbed belts 800, 801. In a multi-ribbed belt, known in the art, a plurality of parallel ribs run in the endless direction on a belt surface. Each idler 700, 701, 702 and 703 has a smooth surface which engages a flat back side of each belt 801, 800 respectively. The inner surface 31 in this embodiment comprises parallel grooves running in an endless direction about the circumference which engage the parallel ribs of each belt 800, 801. Sun gear 175 also comprises parallel grooves on an outer surface running in an endless direction about the circumference which engage the parallel ribs of each belt 800, 801.

FIG. 8 is an exploded view of the v-belt or multi-ribbed belt embodiment. With the exception of the components described in FIG. 7, the components of the transmission are as described in FIG. 2.

Although forms of the invention has been described herein, it will be obvious to those skilled in the art that variations may be made in the construction and relation of parts without departing from the spirit and scope of the invention described herein.

We claim:

1. A belt planetary transmission comprising:
a sun gear (1) having sun gear teeth (11);
a ring gear (3) having ring gear teeth (31);
a first toothed belt (4) trained between a first idler (50) and a second idler (51), the first idler and the second idler rotationally connected to a carrier (2), the first toothed belt (4) in simultaneous meshing contact with the ring gear teeth and the sun gear teeth;
a second toothed belt (40) trained between a third idler (401) and a fourth idler (402), the third idler and the fourth idler rotationally connected to the carrier, the second toothed belt in simultaneous meshing contact with the ring gear teeth and the sun gear teeth;
each of the first idler, second idler, third idler and fourth idler having a center of rotation disposed at a radius (R) from a center of rotation (A-A); and
the first toothed belt and the second toothed belt are each in continuous meshing contact with the ring gear teeth and the sun gear teeth through an angle (α) of approximately 90°.

2. The belt planetary transmission as in claim 1 further comprising:
a first guide member (6) disposed to urge the first toothed belt into meshing contact with the ring gear teeth, the first guide member slidingly contacting the first toothed belt on a side opposite a toothed side.

3. The belt planetary transmission as in claim 2 further comprising:
a second guide member (60) disposed to urge the second toothed belt into meshing contact with the ring gear teeth, the second guide member slidingly contacting the second toothed belt on a side opposite a toothed side.

4. The belt planetary transmission as in claim 1 further comprising a gear attached to the carrier.

5. A belt planetary transmission comprising:
a sun gear (1);
a ring gear (3);
a first multi-ribbed belt (4) trained between a first idler (50 and a second idler (51), the first idler and the second idler rotationally connected to a carrier (2), the first multi-ribbed belt (4) in simultaneous meshing contact with the ring gear and the sun gear;
a second multi-ribbed belt (40) trained between a third idler (401) and a fourth idler (402), the third idler and the fourth idler rotationally connected to the carrier, the second multi-ribbed belt in simultaneous meshing contact with the ring gear and the sun gear;
each of the first idler, second idler, third idler and fourth idler having a center of rotation disposed at a radius (R) from a center of rotation (A-A); and
the first multi-ribbed belt and the second multi-ribbed belt are each in meshing contact with the ring gear and the sun gear through an angle (α) which is approximately 90°.

6. The belt planetary transmission as in claim 5 further comprising:
a first guide member (6) disposed to urge the first multi-ribbed belt into meshing contact with the ring gear, the first guide member slidingly contacting the first multi-ribbed belt on a side opposite a ribbed side.

7. The belt planetary transmission as in claim 6 further comprising:
a second guide member (60) disposed to urge the second multi-ribbed belt into meshing contact with the ring gear, the second guide member slidingly contacting the second multi-ribbed belt on a side opposite a ribbed side.

8. The belt planetary transmission as in claim 5 further comprising a gear attached to the carrier.
